(19) United States
(12) Patent Application Publication
(10) Pub. No.: US 2019/0329934 A1
(43) Pub. Date: Oct. 31, 2019

(54) PACKAGING CONTAINER

(71) Applicant: CJ CHEILJEDANG CORPORATION, Seoul (KR)

(72) Inventors: Byung Kook LEE, Seoul (KR); Yong Hun KIM, Busan (KR); Kwang Soo PARK, Gwacheon-si (KR); Han Seul LEE, Busan (KR); Gyu Hwan CHA, Seoul (KR)

(21) Appl. No.: 16/310,338

(22) PCT Filed: Jun. 28, 2017
(86) PCT No.: PCT/KR2017/006818

§ 371 Date: Dec. 14, 2018

(30) Foreign Application Priority Data
Jun. 29, 2016 (KR) 20-2016-0003790

(51) Int. Cl. B65D 21/02; B65D 1/22; B65D 1/40

(52) U.S. Cl. CPC B65D 21/0233; B29C 51/00; B65D 1/40; B65D 1/22

(57) ABSTRACT

Provided is a packaging container for preventing sealing of packaging containers such that a continuous operation, such as an automatic insertion operation, etc., is able to be smoothly performed in a sequential product packaging process, with easy separation of packaging containers that are vertically stacked.

### TECHNICAL FIELD

The present disclosure relates to a packaging container, and more particularly, to a packaging container which is easily separable from containers due to prevention of adherence and sealing of containers that are vertically stacked, and which allows a continuous operation, such as an automatic insertion operation, etc., to be smoothly performed in a sequential product packaging process.

### BACKGROUND ART

As packaging means of a product, such as food, etc., various “packaging containers” as disclosed in the Korean registered utility model gazette No. 20-0302324 (published on Jan. 30, 2003), etc., are used.

Here, the packaging containers may be manufactured based on any one of injection molding, blow molding, and thermoforming.

The injection molding is a method of injecting and forming a melt resin into a metal mold and is mainly used to manufacture a packaging container having an interior shape and an exterior shape which are different from each other.

The blow molding is a method of molding a melt resin by blowing high pressure air into the melt resin and is mainly used to manufacture a bottle-shaped packaging container.

The thermoforming is a method of forming a synthetic resin sheet having a thickness of 0.3 mm to 3.00 mm by heating and pressing the synthetic resin sheet and is mainly used to manufacture a packaging container having an interior shape and an exterior shape which are the same as each other.

Meanwhile, in order to increase the efficiency of distribution, packaging containers are frequently stored and transported by being piled in a vertical direction, that is, by being stacked, before being used to package products.

In this case, packaging containers formed by injection molding each have an interior shape and an exterior shape which are different from each other, and thus, adherence of the packaging containers is prevented when the packaging containers are vertically stacked. Accordingly, it is easy to separate the packaging containers.

In addition, packaging containers formed by blow molding generally have a bottle-shape. Thus, based on these structural characteristics, the packaging containers are not vertically stacked.

However, packaging containers formed by thermoforming each have an interior shape and an exterior shape which are the same, and thus, when the packaging containers are vertically stacked, an exterior surface of an upper packaging container adheres to an interior surface of a lower packaging container, thereby sealing the containers, and enabling the action of a suction force based on negative pressure, such that it is not easy to separate the packaging containers. Accordingly, when an automatic insertion operation, etc., is to be performed in a sequential product packaging process, continuous operation may be difficult, and thus, the efficiency of a packaging operation may be deteriorated.

Based on the above described reason, it is urgent to develop a packaging container for increasing the efficiency of a packaging operation by enabling smooth and continuous operations, such as an automatic insertion operation, etc., in a sequential product packaging process, with easy separation of packaging containers which are vertically stacked.

### DESCRIPTION OF EMBODIMENTS

### Technical Problem

Provided is a packaging container capable of solving deterioration of the efficiency of a packaging operation due to difficulties in continuous operation when trying to perform an automatic insertion operation, etc., in a sequential product packaging process, in which it is difficult to separate packaging containers due to the action of a suction force based on negative pressure caused by sealing of the packaging containers that are vertically stacked, wherein the packaging containers are formed by thermoforming and the sealing of the packaging containers occurs when an exterior surface of an upper packaging container adheres to an interior surface of a lower packaging container.

### Solution to Problem

According to an aspect of the present disclosure, a packaging container includes: a bottom edge; a wall upwardly extending from the bottom edge; a skirt portion extending from an upper end of the wall and formed with a step difference from the wall; and a flange formed along an upper end of the skirt portion and having an upper surface onto which a lead film is sealed, wherein the skirt portion includes an insertion groove at a lower end of an exterior surface of the skirt portion, wherein the insertion groove has an inwardly concave shape.

The insertion groove may include three to eight insertion grooves, wherein the three to eight insertion grooves are formed at regular intervals at the lower end of the exterior surface of the skirt portion.

The insertion groove may have a height of 0.5 mm to 2.0 mm.

The insertion groove may have a width of 1.0 mm to 5.0 mm.

The insertion groove may have a polygonal shape or an arc shape.

### Advantageous Effects of Disclosure

According to a packaging container according to the present disclosure, an insertion groove is formed at a lower end of an exterior surface of a skirt portion, and thus, when the packaging container is vertically stacked with another packaging container, a non-contact portion occurs due to the insertion groove when a lower surface of the skirt portion of an upper packaging container contacts an upper surface of a flange of a lower packaging container, wherein the non-contact portion forms an air passage. Thus, the packaging containers may be prevented from adhering to each other and being sealed, and it may be easy to separate the packaging containers that are vertically stacked. Accordingly, a continuous operation may be smoothly performed when an automatic insertion operation, etc., is to be performed in a sequential product packaging process, to increase the efficiency of a packaging operation.

### BRIEF DESCRIPTION OF DRAWINGS

FIG. 1 is a perspective view of an exterior form of a packaging container according to the present disclosure.

FIG. 2 is a bottom-side perspective view of an exterior form of a packaging container according to the present disclosure.

FIG. 3 is a cross-sectional view for describing a structure of a packaging container according to the present disclosure.

FIG. 4 is an example view of a state in which packaging containers are vertically stacked, according to the present disclosure.

FIG. 5 is an example view for describing prevention of sealing in a packaging container via an insertion groove, according to the present disclosure.

FIG. 6 is an example view of a packaging container including an insertion groove having an arc shape, according to the present disclosure.

### MODE OF DISCLOSURE

Hereinafter, the present disclosure will be described in detail with reference to the accompanying drawings.

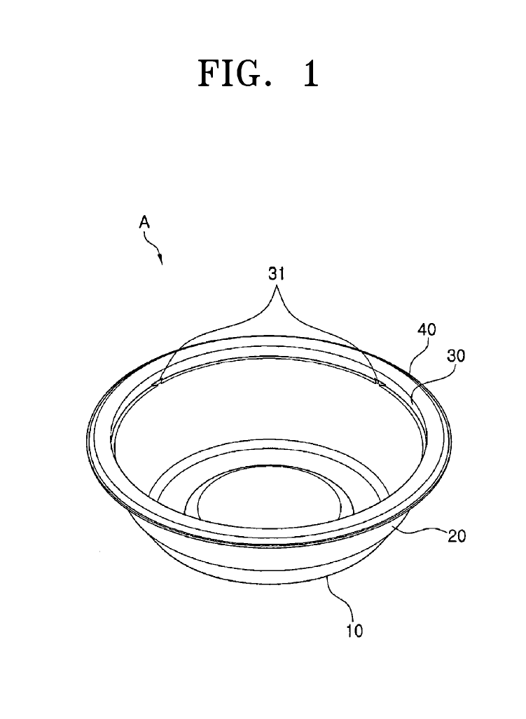

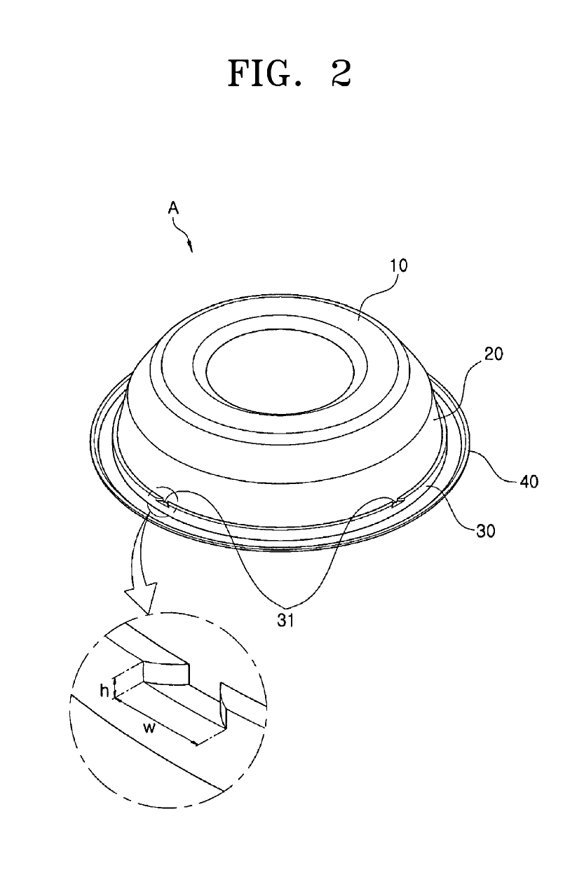

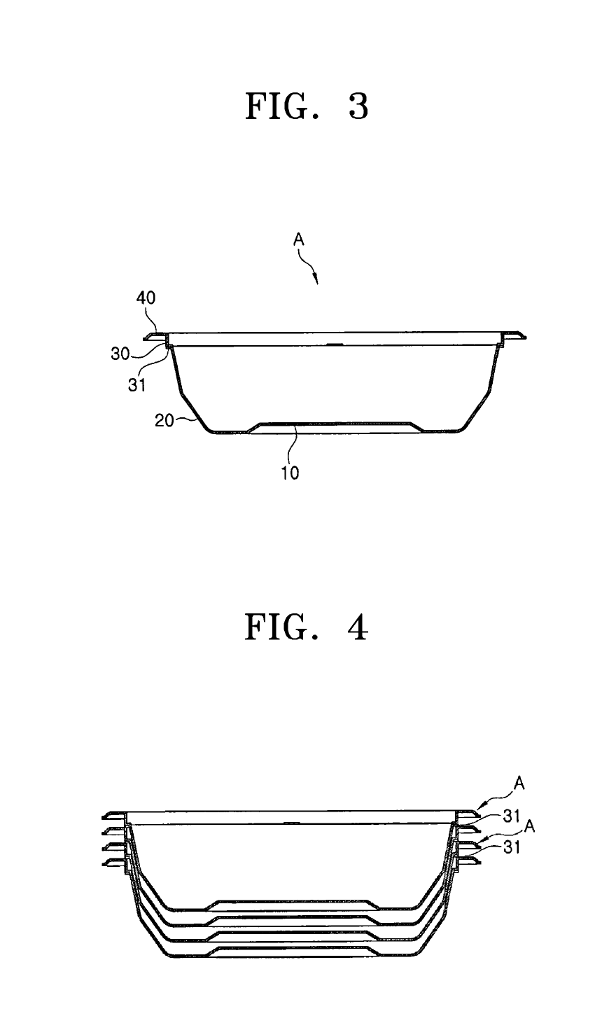

As illustrated in FIGS. 1 through 3, a “packaging container” (hereinafter, referred to as a “container”) A according to the present disclosure may include a bottom edge 10, a wall 20, a skirt portion 30, and a flange 40.

The bottom edge 10 may provide a mounting surface for a product (not shown in the drawing).

The bottom edge 10 may be generally formed to be flat, and thus, a product (not shown in the drawing) may be stably supported by the bottom edge 10.

The wall 20 may be formed to extend upwardly from an edge of the bottom edge 10.

A space defined above the bottom edge 10 may be formed due to the wall 20 to accommodate the product.

The skirt portion 30 may extend from an upper end of the wall 20 and may be formed to have a step difference from the wall 20.

The skirt portion 30 may include an insertion groove 31 at a lower end of an exterior surface of the skirt portion 30, wherein the insertion groove 31 is formed to be inwardly concave.

Since the skirt portion 30 includes the insertion groove 31, when the container A is vertically stacked with another container, a non-contact portion, that is, an open portion, occurs due to the insertion groove 31 when a lower surface of the skirt portion 30 of an upper container A contacts an upper surface of the flange 40 of a lower container A, so that an air passage is formed through the non-contact portion. Thus, sealing of the containers A due to adherence to each other may be prevented, and it may be easy to separate the containers A when the containers A are vertically stacked

Here, it is desirable that the insertion groove 31 include three to eight insertion grooves formed at a lower end of an outer circumferential surface of the skirt portion 30 in a constant interval.

When the insertion groove 31 includes less than three insertion grooves, the non-contact portion between the upper container A and the lower container A in the vertically stacked containers A, the non-contact portion occurring due to the insertion groove 31, may become insignificant, and thus, the prevention of sealing between the containers A may not be significant. When the insertion groove 31 includes more than eight insertion grooves, it may be burdensome to manufacture a metal mold for forming the container A. Thus, desirably, the insertion groove 31 includes three to eight insertion grooves formed at the lower end of the exterior surface of the skirt portion 30 in a constant interval.

In addition, it is desirable that the insertion groove 31 be formed to have a height h of 0.5 to 2.0 mm.

When the height h of the insertion groove 31 is less than 0.5 mm, the non-contact portion between the upper container A and the lower container A in the vertically stacked containers A, the non-contact portion occurring due to the insertion groove 31, may become insignificant, and thus, the prevention of sealing between the containers A may not be significant. When the height h of the insertion groove 31 is greater than 2.0 mm, impurities, etc. may penetrate between the vertically stacked containers A, through the insertion groove 31. Thus, desirably, the insertion groove 31 is formed to have the height h of 0.5 to 2.0 mm.

Also, it is desirable that the insertion groove 31 be formed to have a width w of 1.0 to 5.0 mm.

When the width w of the insertion groove 31 is less than 1.0 mm, the non-contact portion between the upper container A and the lower container A in the vertically stacked containers A, the non-contact portion occurring due to the insertion groove 31, may become insignificant, and thus, the prevention of sealing between the containers A may not be significant. When the width w of the insertion groove 31 is greater than 5.0 mm, impurities, etc. may penetrate between the vertically stacked containers A, through the insertion groove 31. Thus, desirably, the insertion groove 31 is formed to have the width w of 1.0 to 5.0 mm.

Here, the insertion groove 31 may have any shape, whereby a non-contact portion may be generated between the upper container A and the lower container A in the vertically stacked containers A. Examples of the shape of the insertion groove 31 may include a polygonal shape, or an arc shape illustrated in FIG. 6.

The flange 40 may be formed along the upper end of the skirt portion 30.

A lead film (not shown in the drawing) may be sealed onto an upper surface of the flange 40, so that the product accommodated in the wall 20 may be sealed.

Meanwhile, the bottom edge 10, the wall 20, the skirt portion, and the flange 40 are formed by using a flexible synthetic resin, and thus, based on this materialistic characteristic, shocks from the outside in a distribution process may be alleviated to minimize damage and deformation.

Also, the container A is formed based on thermoforming, and based on the characteristic of this forming method, an interior shape and an exterior shape of the container A may become uniform.

The vertically stacked containers A according to the present disclosure will be described in detail below.

The wall 20 in the container A according to the present disclosure may be in a state, in which an upper portion of the wall 20 is open, before a product is packaged.

Thus, as illustrated in FIG. 4, it is possible to insert another container A into an inner side of any one of the containers A. Accordingly, the containers A may be vertically stacked.

Here, the bottom edge 10 of an upper container A may be inserted into an inner side of the wall 20 of a lower container A, and a lower surface of the skirt portion 30 of the upper container A may contact an upper surface of the flange 40 of the lower container A, and thus, the insertion of the upper container A into the inner side of the lower container A may be restricted.

However, when the entire circumference of the lower surface of the skirt portion 30 of the upper container A adheres to the entire circumference of the upper surface of the flange 40 of the lower container A, when the containers A are vertically stacked, the upper container A and the lower container A may be sealed and a suction force due to negative pressure may be applied, so that it may be difficult to separate the containers A.

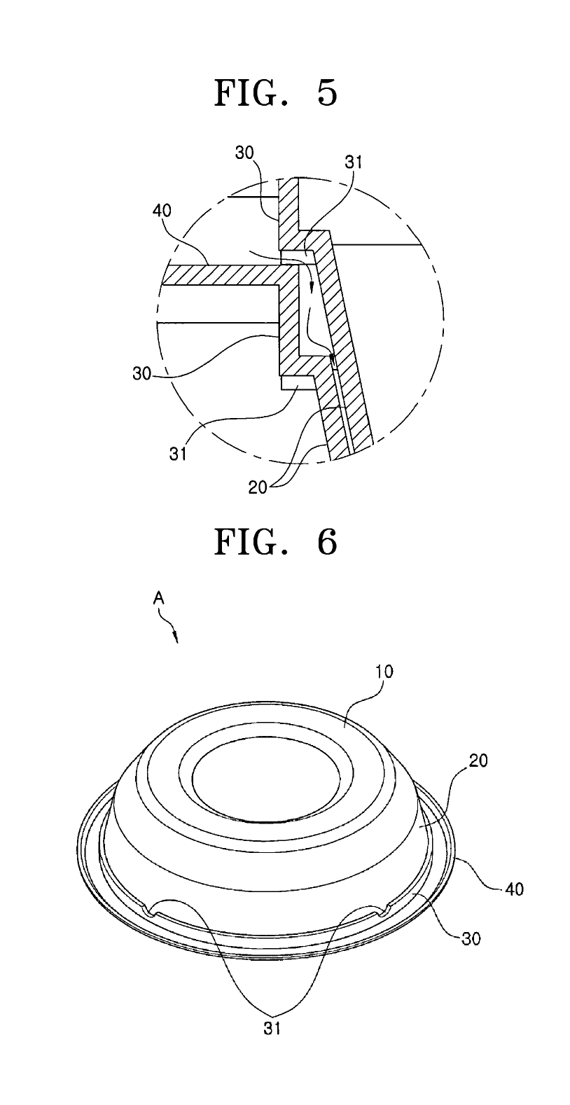

However, the skirt portion 30 according to the present disclosure includes the insertion groove 31 formed inwardly concave at the lower end of the exterior surface of the skirt portion 30, and thus, as illustrated in FIG. 5, when the lower surface of the skirt portion 30 of the upper container A contacts the upper surface of the flange 40 of the lower container A, a non-contact portion, that is, an open portion, may be generated due to the insertion groove 31, and air may pass (refer to the indication of an arrow of FIG. 5) between the upper container A and the lower container A. Accordingly, the containers A may be prevented from adhering to each other and being sealed, and thus, the containers A may be easily separated when the containers A are vertically stacked.

Thus, in a sequential product packaging process, when the containers A according to the present disclosure are vertically stacked and an automatic insertion operation, etc., is performed by using an automatic insertion device (not shown in the drawing), etc., a continuous operation may be smoothly performed with easy separation between the containers A, so that the efficiency of a packaging operation may be increased

As described above, according to the packaging container A according to the present disclosure, the insertion groove 31 is formed at the lower end of the exterior surface of the skirt portion 30, and thus, when the lower surface of the skirt portion 30 of the upper container A and the upper surface of the flange 40 of the lower container A contact each other when the containers A are vertically stacked, the non-contact portion forming an air passage may be generated due to the insertion groove 31. Thus, adherence and sealing between the containers A may be prevented, and it may be easy to separate the containers A when the containers A are vertically stacked. Accordingly, when an automatic insertion process, etc. is to be performed in a sequential product packaging process, a continuous operation may be smoothly performed to increase the efficiency of the packaging operation.

The present disclosure described above is not limited to the embodiments described above, and changes may be made therein without departing from the spirit and scope of the present disclosure as defined by the following claims, and the changes are within the protection scope of the present disclosure as defined by the following claims.

1. A packaging container comprising:
a bottom edge;
a wall upwardly extending from the bottom edge;
a skirt portion extending from an upper end of the wall and formed with a step difference from the wall; and
a flange formed along an upper end of the skirt portion and having an upper surface onto which a lead film is sealed,
wherein the skirt portion comprises an insertion groove at a lower end of an exterior surface of the skirt portion, wherein the insertion groove has an inwardly concave shape.

2. The packaging container of claim 1, wherein the insertion groove comprises three to eight insertion grooves, wherein the three to eight insertion grooves are formed at regular intervals at the lower end of the exterior surface of the skirt portion.

3. The packaging container of claim 1, wherein the insertion groove has a height of 0.5 mm to 2.0 mm.

4. The packaging container of claim 1, wherein the insertion groove has a width of 1.0 mm to 5.0 mm.

5. The packaging container of claim 1, wherein the insertion groove has a polygonal shape or an arc shape.

6. The packaging container of claim 1, wherein the packaging container is formed by thermoforming.
